(19) United States
(12) Patent Application Publication
(10) Pub. No.: US 2025/0289072 A1
(43) Pub. Date: Sep. 18, 2025

(54) BAND SAW

(71) Applicant: MILWAUKEE ELECTRIC TOOL CORPORATION, Brookfield, WI (US)

(72) Inventors: Wesley S. Bassindale, Wauwatosa, WI (US); Jonathan E. Schmitz, Wauwatosa, WI (US)

(21) Appl. No.: 19/223,781

(22) Filed: May 30, 2025

Related U.S. Application Data
(63) Continuation of application No. 18/167,940, filed on Feb. 13, 2023, now Pat. No. 12,325,080.
(60) Provisional application No. 63/309,716, filed on Feb. 14, 2022.

(51) Int. Cl. B23D 53/12; B23D 55/06

(52) U.S. Cl. CPC B23D 53/12; B23D 55/065

(57) ABSTRACT

A band saw includes a housing, a motor, a drive pulley configured to receive torque from the motor, causing the drive pulley to rotate, and a plurality of driven pulleys rotatably coupled to a plate that is coupled to the housing for sliding movement. The band saw further includes a cavity within the housing and located between the drive pulley and the plurality of driven pulleys and an endless saw blade wrapped around the drive pulley and the plurality of driven pulleys. The endless saw blade passes through the cavity. Moreover, the band saw includes a guide roller set coupled to the housing and configured to support the endless saw blade as the endless saw blade passes through the cavity. The plurality of driven pulleys gradually impart a twisting movement on the endless saw blade prior to the endless saw blade passing though the cavity.

### CROSS-REFERENCE TO RELATED APPLICATIONS

This application is a continuation of co-pending U.S. patent application Ser. No. 18/167,940 filed on Feb. 13, 2023, which claims priority to U.S. Provisional Patent Application No. 63/309,716 filed on Feb. 14, 2022, the entire contents of all of which are incorporated herein by reference.

### FIELD OF THE INVENTION

The present invention relates to power tools, and, more particularly, to band saws.

### BACKGROUND OF THE INVENTION

Band saws are generally used for various cutting operations, such as for cutting pipe, conduit, and a variety of other materials. Band saws generally include a powered, drive pulley and a non-powered, driven pulley that are connected by a continuous saw blade. The saw blade, in turn, transfers torque to the driven pulley, causing it to rotate with the drive pulley during a cutting operation.

### SUMMARY OF THE INVENTION

The present invention provides, in one aspect, a band saw including a housing, a motor supported by the housing, a drive pulley configured to receive torque from the motor, causing the drive pulley to rotate, and a plurality of driven pulleys rotatably coupled to a plate. The plate is coupled to the housing for sliding movement. The band saw further includes a cavity within the housing and located between the drive pulley and the plurality of driven pulleys and an endless saw blade wrapped around the drive pulley and the plurality of driven pulleys. The endless saw blade passes through the cavity and configured to be driven by the drive pulley. Moreover, the band saw includes a guide roller set coupled to the housing and configured to support the endless saw blade as the endless saw blade passes through the cavity. The plurality of driven pulleys gradually impart a twisting movement on the endless saw blade prior to the endless saw blade passing though the cavity.

The present invention provides, in another aspect, a band saw including a housing, a motor supported by the housing, a drive pulley configured to receive torque from the motor, causing the drive pulley to rotate, a plurality of driven pulleys, and a cavity within the housing and located between the drive pulley and the plurality of driven pulleys. The band saw further includes an endless saw blade wrapped around the drive pulley and the plurality of driven pulleys. The endless saw blade passes through the cavity and is configured to be driven by the drive pulley. Moreover, the band saw includes a first guide roller set disposed on a first side of the cavity and configured to support the endless saw blade as the endless saw blade passes through the cavity, and a second guide roller set disposed on a second side of the cavity opposite the first side and configured to support the endless saw blade as the endless saw blade passes through the cavity. The plurality of driven pulleys gradually impart a twisting movement on the endless saw blade prior to the endless saw blade passing though the cavity.

The present invention provides, in another aspect, a band saw including a housing, a motor supported by the housing, a drive pulley configured to receive torque from the motor, causing the drive pulley to rotate, and a plurality of driven pulleys rotatably coupled to a plate. Each driven pulley is rotatably supported to the plate by a support shaft. The band saw further includes a cavity within the housing and located between the drive pulley and the plurality of driven pulleys and an endless saw blade wrapped around the drive pulley and the plurality of driven pulleys. The endless saw blade passes through the cavity and is configured to be driven by the drive pulley. Moreover, the band saw includes a guide roller set coupled to the housing and configured to support the endless saw blade as the endless saw blade passes through the cavity. The plurality of driven pulleys gradually impart a twisting movement on the endless saw blade prior to the endless saw blade passing though the cavity.

### BRIEF DESCRIPTION OF DRAWINGS

FIG. 1 is a front perspective view of a band saw according to an embodiment of the present invention.

FIG. 2 is a side view of the band saw of FIG. 1, illustrating a drive pulley and plurality of driven pulleys.

FIG. 3 is a side perspective view of a driven pulley assembly, illustrating the plurality of driven pulleys of FIG. 2 coupled to a plate and a tensioning assembly.

FIG. 4 is an opposite side perspective view of the driven pulley assembly of FIG. 3.

FIG. 5 is a front perspective view of a single driven pulley coupled to a shaft.

FIG. 6 is a rear perspective view of the driven pulley of FIG. 5.

FIG. 7 is a perspective view of the shaft of FIG. 5.

FIG. 8A is a schematic side view of the driven pulley assembly of FIG. 3, illustrating a first of the driven pulleys oriented at an oblique angle relative to the plate.

FIG. 8B is a schematic side view of the driven pulley assembly of FIG. 3, illustrating a second of the driven pulleys oriented at an oblique angle relative to the plate.

FIG. 8C is a schematic side view of the driven pulley assembly of FIG. 3, illustrating a third of the driven pulleys oriented at an oblique angle relative to the plate.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

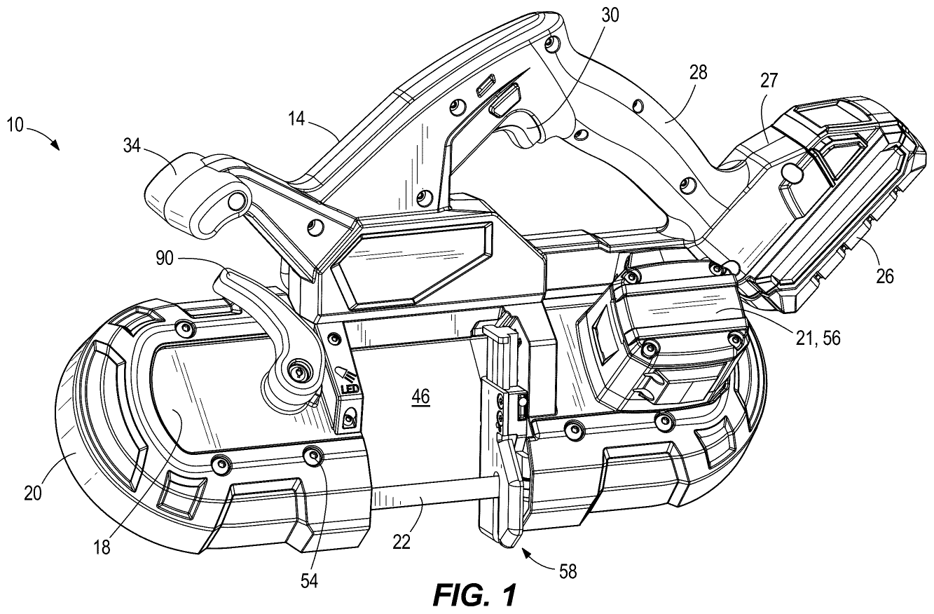

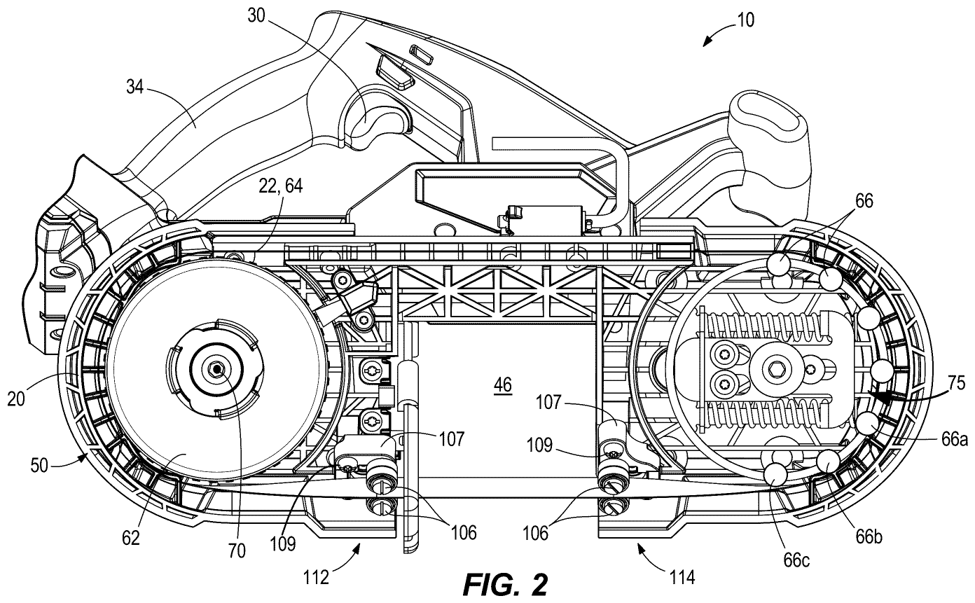

FIGS. 1 and 2 illustrate a band saw 10 including a housing 14 having a deck 18 and a guard 20 coupled to the deck 18. The deck 18 supports a motor 21 and, in some embodiments, a gear train (not shown). The gear train may take any of a number of different arrangements configured to convert the relatively high-speed, low-torque input provided by the motor 21 to a relatively low-speed, high-torque output. The motor 21 is operable to drive a continuous band saw blade 22 to cut a work piece. The motor 21 is configured as a brushless DC motor, in which a battery pack 26 is utilized to provide power to the brushless DC motor. Such a battery pack 26 may be configured having any of a number of different voltages (e.g., 12, 14.4, 18, 24, 28 volts, etc.). Such a battery pack 26 may also be configured having any of a number of different chemistries (e.g., Lithium-ion, Nickel Cadmium, Nickel Metal-Hydride, etc.). The battery pack 26 is configured to be received within a battery receptacle 27.

With continued reference to FIGS. 1 and 2, the band saw 10 includes a primary handle 28 supporting the battery pack 26 and a switch assembly 30 configured to operate the band saw 10. The switch assembly 30 is operable to control operation of the motor 21. The band saw 10 also includes an auxiliary handle 34 for a user's other hand. Generally, the handles 28, 34 are shaped and arranged for two-handed operation of the band saw 10 as the work piece is cut. In the illustrated embodiment of the band saw 10, each handle 28, 34 has an ergonomic design to provide comfortable gripping and controlled operation of the band saw 10. The ergonomic design of each handle 28, 34 may result from the orientation or angle of one or more of the handles 28, 34. The ergonomic design may also result from the use of material, such as an elastomeric material, on one or more of the handles 28, 34 to provide an improved grip surface, isolate vibration and impacts from the operator, prevent heat build-up and/or heat transfer to the operator, etc.

A combination of the deck 18 and the guard 20 defines a cavity 46 in which a work piece is received during a cutting operation. While the saw blade 22 is exposed across a length of the cavity 46, the guard 20 provides a recessed area 50 in which a substantial portion of the band saw blade 22 is positioned (FIG. 2). In the illustrated embodiment of the band saw 10, the guard 20 is formed as a separate piece from the deck 18 and is removably coupled to the deck 18 (e.g., using fasteners 54; see FIG. 1). The guard 20 is made of a hard plastic or polymer material and is positioned around a perimeter of the deck 18 to protect the perimeter of the deck 18 from bumps and scratches that occur during use. Alternatively, the deck 18 and the guard 20 may be integrally formed as a single piece. The deck 18 includes a motor housing portion 56 that encloses the motor 21 and, if used, the gear train. The band saw 10 also includes a shoe 58 coupled to the housing 14 and having a support surface against which a work piece is abutted during a cutting operation.

With reference to FIG. 2, the band saw 10 includes a first guide roller set 112 disposed on one side of the cavity 46 and a second guide roller set 114 disposed on an opposite side of the cavity 46. Each of the guide roller sets 112, 114 includes aligned rollers 106 with which opposite sides of the saw blade 22 are engaged and a mounting block 107 to which the rollers 106 are rotatably supported. The mounting blocks 107 are coupled to the deck 18 using fasteners (e.g., bolts or screws 109). The first and second guide roller sets 112, 114 support the band saw blade 22 as the blade 22 moves across the cavity 46.

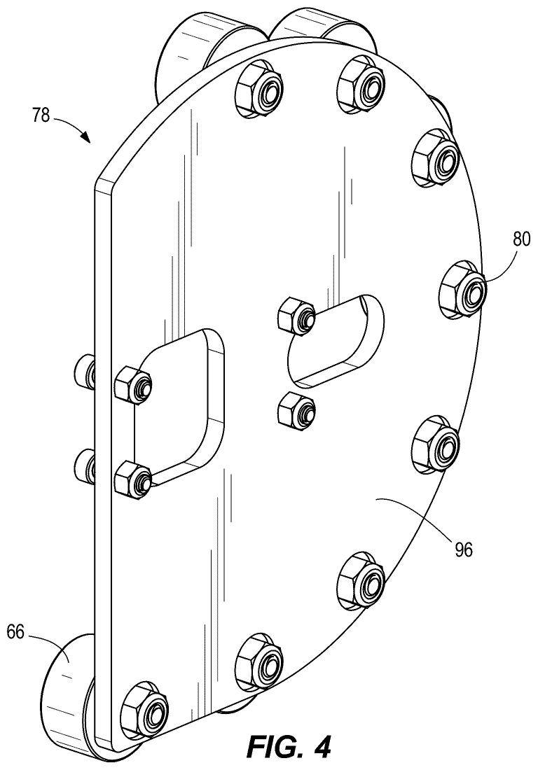

With reference to FIGS. 2-4, the band saw 10 includes a drive pulley 62 and a plurality of driven pulleys 66. The outer peripheral surface and an interior side of each of the drive pulley 62 and the plurality of driven pulleys 66 are covered by the deck 18 and the guard 20. The drive pulley 62 rotates about a drive pulley axis 70 defined by a drive pulley spindle (not shown). The drive pulley spindle is rotationally supported by the gear train. The drive pulley 62 is drivingly connected to the motor 21 via the gear train and the drive pulley spindle. In some embodiments, the gear train is located between the motor 21 and the drive pulley 62. In other embodiments, the motor 21 may directly drive the drive pulley 62 without an intervening gear train. Each of the driven pulleys 66 rotates about a shaft 74 configured to rotatably couple each driven pulley 66 to a plate 78 which, in turn, is coupled to the housing 14. In some embodiments, the distance of the plate 78 relative to the drive pulley axis 70 is adjustable to adjust the tension applied to the saw blade 22. The band saw blade 22 extends around the drive pulley 62 and the plurality of driven pulleys 66, defining an oblong path 64. As a result, motion from the drive pulley 62 is transmitted to the band saw blade 22.

The band saw 10 also includes a blade tensioning assembly 75 having a blade tensioning lever 90 coupled to the deck 18 to adjust the amount of tension applied to the band saw blade 22. The blade tensioning assembly 75 further includes a tensioning plate 77, a tensioning bracket 79, a pair of pins 81, a pair of springs 83, and a contact plate 85. At a first end of the blade tensioning assembly 75, the tensioning plate 77 and the tensioning bracket 79 are coupled together by the contact plate 85. The contact plate 85 includes a pair of bracket apertures 87 configured to receive the tensioning bracket 79 and a plate aperture (not shown) configured to receive the tensioning plate 77. At a second end of the blade tensioning assembly 75, the tensioning bracket 79 extends through a pair of apertures 89 formed in the tensioning plate 77. The pair of pins 81, specifically coil pins, are inserted into a pair of pin holes 91 formed in the tensioning bracket 79, to further secure the tensioning bracket 79 to the tensioning plate 77. As such, the tensioning bracket 79 is affixed to the housing 14, and therefore is stationary. The tensioning plate 77 and the plate 78 are configured to move in a front direction and a rear direction to increase or decrease the tension in the band saw blade 22 as the lever 90 is adjusted by a user. The tensioning plate 77 is coupled to the plate 78 via fasteners (not shown), such that the tensioning plate 77 and the plate 78 are configured to move in unison as the lever 90 is operated. When the springs 83 rebound, the springs 83 apply tension to the band saw blade 22. As the spring 83 are compressed, the tension in the band saw blade 22 is released so that the saw blade 22 can be removed or replaced from the band saw 10.

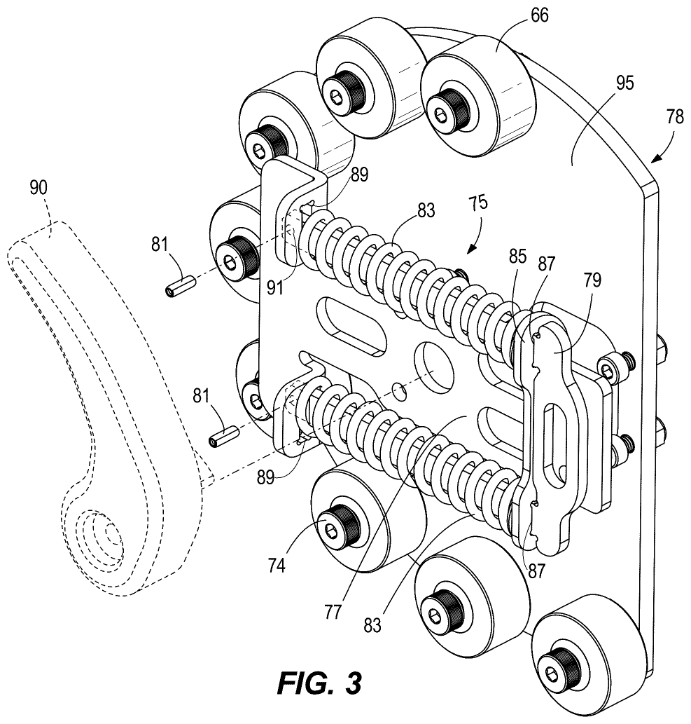

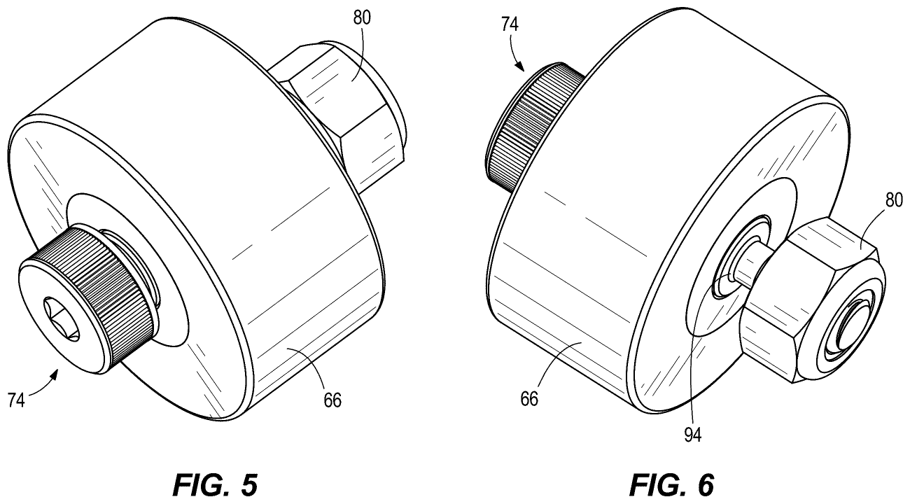

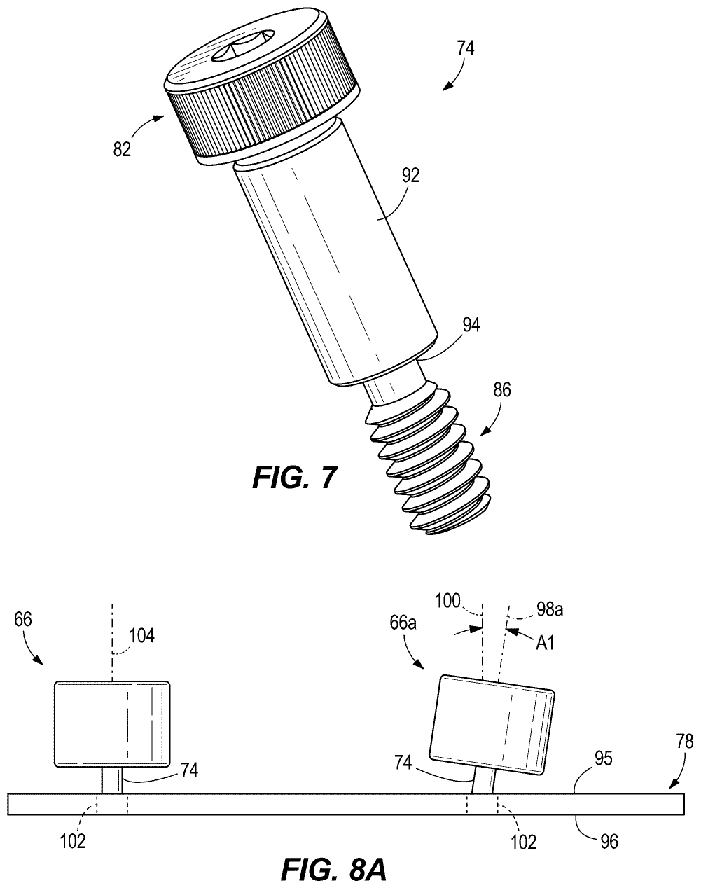

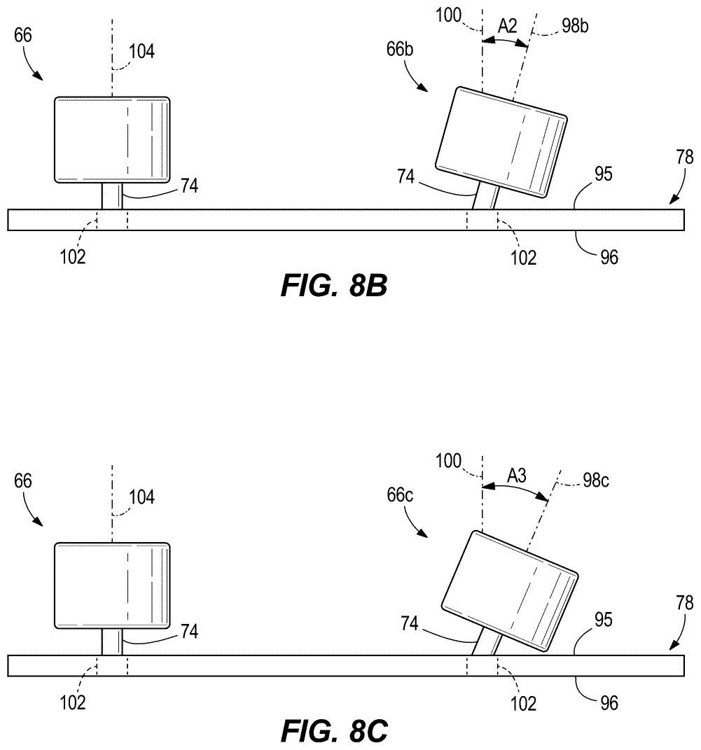

With reference to FIGS. 5-7, the shafts 74 of each driven pulley 66 are configured as a shoulder bolt including a first end or head 82, a second or threaded end 86 opposite the head 82, and an unthreaded, cylindrical shank 92 between the head 82 and the threaded end 86. The shafts 74 also include a shoulder 94 adjacent the shank 92 that is seated against a front side 95 of the plate 78 (FIG. 3). A nut 80 is threaded to the threaded end 86 and is seated against a rear side 96 of the plate 78 (FIG. 3), thereby clamping the plate 78 between the shoulder 94 and the nut 80. The threaded end 86 is configured to be at least partially received within a hole 102 (FIGS. 8A-8C) in the plate 78, with the threaded end 86 protruding through the hole 102 to receive the nut 80. The holes 102 may be unthreaded or threaded, in which the case the threads in the holes 102 would have a corresponding pitch as the threaded end 86.

With reference to FIGS. 2 and 8A-8C, the driven pulleys 66 are mounted on the plate 78 in a manner to gradually impart a twisting movement on the saw blade 22, over multiple of the driven pulleys 66, along the oblong path 64 leading to the cavity 46. Most of the driven pulleys 66 are rotatable about an axis 104 that is defined by the shaft 74 and oriented perpendicular to the plate 78 (e.g., driven pulleys 66 in FIGS. 8A-8C). However, several of the driven pulleys 66a-66c are mounted to the plate 78 such that the rotational axes 98a-98c of the respective driven pulleys 66a-66c are obliquely oriented relative to the plate 78 to define an inclination angle A measured relative to a normal 100 extending from the plate 78. The driven pulleys 66 are capable of having an inclination angle A that ranges from 0 degrees to 45 degrees to facilitate various twisting movements on the saw blade 22 along the oblong path 64.

Preferably, the inclination angle A of each driven pulley 66a-66c gradually increases along the oblong path 64, traveling towards the cavity 46. The inclination angle A is at a maximum value proximate the cavity 46. In the illustrated embodiment of FIGS. 2 and 8A-8C, the rotational axis 98a of a first driven pulley 66a is oriented at an inclination angle A1 of 15 degrees, the rotational axis 98b of a second driven pulley 66b positioned at an inclination angle A2 of 30 degrees, and the rotational axis 98c of a third driven pulley 66c having an inclination angle A3 of 45 degrees. In some embodiments of the band saw 10, the inclination angle A of the last driven pulley 66c along the oblong path 64 of the saw blade 22 is oriented at an angle that matches a tilt angle of the saw blade 22 prior to passing through the cavity 46. In such an arrangement, the tilt angle of the saw blade 22 is unchanged between the last driven pulley 66c and the second guide roller set 114.

In operation of the band saw 10, the user depresses the switch assembly 30 positioned on the primary handle 28 to actuate the motor 21. The motor 21 outputs a torque through an output shaft (not shown) of the motor 21, in which the torque is transferred to the drive pulley 62 via the gear train and the drive pulley spindle. The drive pulley 62 is driven to rotate, causing the saw blade 22 to rotate and in turn, rotate the driven pulleys 66. As the saw blade 22 passes through the cavity 46, the user is allowed to complete a cutting operation.

Along the oblong path 64 of the saw blade 22, the driven pulleys 66 form a semi-circular path, in place of a single large-diameter driven pulley having the same size as the drive pulley 62, which permits the width of the cavity 46 to be increased compared to a traditional band saw 10 having a single large-diameter driven pulley having the same size as the drive pulley 62. Therefore, the increased width of the cavity 46 provides the user with more space to complete a cutting operation of a work piece.

To sustain the fatigue life of the saw blade 22, the distance over which the saw blade 22 is twisted should extend at an appropriate distance along the oblong path 64. By twisting the saw blade 22 to a desired tilt angle over an increased distance over the oblong path 64 leading to the cavity 46, the fatigue life of the saw blade 22 is increased compared to a traditional band saw 10, which requires the saw blade 22 to twist to a desired tilt angle over a shorter distance along the oblong path 64 (i.e., between the single large-diameter driven pulley and the second guide roller set 114).

Although the invention has been described in detail with reference to certain preferred embodiments, variations and modifications exist within the scope and spirit of one or more independent aspects of the invention as described.

What is claimed is:

1. A band saw comprising:
a housing;
a motor supported by the housing;
a drive pulley configured to receive torque from the motor, causing the drive pulley to rotate;
a plurality of driven pulleys rotatably coupled to a plate, the plate being coupled to the housing for sliding movement;
a cavity within the housing and located between the drive pulley and the plurality of driven pulleys;
an endless saw blade wrapped around the drive pulley and the plurality of driven pulleys, the endless saw blade passing through the cavity and configured to be driven by the drive pulley; and
a guide roller set coupled to the housing and configured to support the endless saw blade as the endless saw blade passes through the cavity,
wherein the plurality of driven pulleys gradually impart a twisting movement on the endless saw blade prior to the endless saw blade passing though the cavity.

2. The band saw of claim 1, wherein the guide roller set is a first guide roller set disposed on a first side of the cavity, and wherein the band saw further comprises a second guide roller set disposed on a second side opposite the first side of the cavity.

3. The band saw of claim 2, wherein each guide roller set includes aligned rollers configured to engage the endless saw blade.

4. The band saw of claim 3, wherein each guide roller set includes a mounting block configured to rotatably support the aligned rollers, and wherein the mounting block of each guide roller set is coupled to the housing.

5. The band saw of claim 1, wherein at least one driven pulley of the plurality of driven pulleys is rotatable about an axis that is obliquely oriented relative to the plate to impart the twisting movement to the endless saw blade.

6. The band saw of claim 5, wherein the axis defines an inclination angle of 15 degrees relative to a normal extending from the plate and within a common plane as the axis.

7. The band saw of claim 5, wherein the axis defines an inclination angle of 30 degrees relative to a normal extending from the plate and within a common plane as the axis.

8. The band saw of claim 5, wherein the axis defines an inclination angle of 45 degrees relative to a normal extending from the plate and within a common plane as the axis.

9. A band saw comprising:
a housing;
a motor supported by the housing;
a drive pulley configured to receive torque from the motor, causing the drive pulley to rotate;
a plurality of driven pulleys;
a cavity within the housing and located between the drive pulley and the plurality of driven pulleys;
an endless saw blade wrapped around the drive pulley and the plurality of driven pulleys, the endless saw blade passing through the cavity and configured to be driven by the drive pulley;
a first guide roller set disposed on a first side of the cavity and configured to support the endless saw blade as the endless saw blade passes through the cavity; and
a second guide roller set disposed on a second side of the cavity opposite the first side and configured to support the endless saw blade as the endless saw blade passes through the cavity,
wherein the plurality of driven pulleys gradually impart a twisting movement on the endless saw blade prior to the endless saw blade passing though the cavity.

10. The band saw of claim 9, wherein each guide roller set includes aligned rollers configured to engage the endless saw blade.

11. The band saw of claim 10, wherein each guide roller set includes a mounting block configured to rotatably support the aligned rollers, and wherein the mounting block of each guide roller set is coupled to the housing.

12. A band saw comprising:
a housing;
a motor supported by the housing;
a drive pulley configured to receive torque from the motor, causing the drive pulley to rotate;
a plurality of driven pulleys rotatably coupled to a plate, each driven pulley is rotatably supported to the plate by a support shaft;
a cavity within the housing and located between the drive pulley and the plurality of driven pulleys;
an endless saw blade wrapped around the drive pulley and the plurality of driven pulleys, the endless saw blade passing through the cavity and configured to be driven by the drive pulley; and
a guide roller set coupled to the housing and configured to support the endless saw blade as the endless saw blade passes through the cavity,
wherein the plurality of driven pulleys gradually impart a twisting movement on the endless saw blade prior to the endless saw blade passing though the cavity.

13. The band saw of claim 12, wherein the guide roller set is a first guide roller set disposed on a first side of the cavity, and wherein the band saw further comprises a second guide roller set disposed on a second side of the cavity opposite the first side.

14. The band saw of claim 13, wherein each guide roller set includes aligned rollers configured to engage the endless saw blade.

15. The band saw of claim 14, wherein each guide roller set includes a mounting block configured to rotatably support the aligned rollers, and wherein the mounting block of each guide roller set is coupled to the housing.

16. The band saw of claim 12, wherein a rotational axis of at least one driven pulley defines a maximum inclination angle measured relative to a normal extending from the plate when the at least one driven pulley is proximate the cavity.

17. The band saw of claim 12, wherein each support shaft defines a rotational axis and is configured to be tilted such that the rotational axis defines an inclination angle measured relative to a normal extending from the plate, and wherein the inclination angle ranges from 0 degrees to 45 degrees to facilitate the twisting movement to the endless saw blade.

18. The band saw of claim 12, wherein each support shaft is configured as a shoulder bolt including a first end, a second end opposite the first end, and a cylindrical shank disposed between the first end and the second end.

19. The band saw of claim 18, wherein each driven pulley is positioned along the cylindrical shank of each support shaft.

20. The band saw of claim 19, wherein the second end of each support shaft is configured to be received within a hole formed within the plate.
